(19) United States
(12) Patent Application Publication
(10) Pub. No.: US 2005/0081138 A1
(43) Pub. Date: Apr. 14, 2005

(54) Systems and methods for associating an image with a video file in which the image is embedded

(76) Inventors: James S. Voss, Ft. Collins, CO (US); Jim Owens, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/670,933

(22) Filed: Sep. 25, 2003

(51) Int. Cl. G06F 17/21; G06F 17/24; G06F 17/00; G06F 15/00; H04N 7/16

(52) U.S. Cl. 715/500.1; 715/512; 725/135

(57) ABSTRACT

Disclosed are systems and methods for associating an image with a video file. In one embodiment, a system and a method pertain to identifying a video file that contains an identified image that is to be stored as a separate still image file, and storing association data along with the still image file that associates the still image file with the video file.

### BACKGROUND

Digital technology is beginning to be used more frequently to capture video data. Such video data is captured with digital video cameras or digital still cameras having a “movie” mode functionality. To create digital video, the camera captures multiple, relatively low-resolution images, or frames, per second. By way of example, a resolution of 640 pixels by 480 pixels, commonly referred to as video graphics array (VGA) resolution, at a frame rate of 15 frames per second (fps) or more.

The relatively-low resolution used to capture video data is normally considered acceptable in that relatively high-quality video can be produced with such a resolution given that so many frames are captured, and therefore will be viewed, per second. Unfortunately, however, the relatively low-resolution used to capture video data is less acceptable when the data is not merely viewed as video. For example, if the user wishes to extract one of the frames of a given video file for purposes of creating a hard copy printout or to simply view as a still image (e.g., in a screen saver or as a desktop background), the relatively low-resolution of the frame will yield a relatively low-quality result.

Although an obvious solution to the above-described problem would be to simply only capture high-resolution images (e.g., images having a resolution of 2 or more megapixels), such a solution is not feasible with current digital technology. Specifically, the time required to capture and process high-resolution images prevents a large number of images (e.g., 15-30) from being captured per second. Accordingly, the camera designer is typically left with a choice between capturing relatively low-resolution images at a high frame rate, which provides acceptable video but unacceptable still images, or capturing relatively high-resolution images at a low frame rate, which provides acceptable still images but unacceptable video.

In view of the limitations of current digital technologies, a hybrid solution is currently being investigated. In particular, at least one manufacturer is developing cameras that, during a given capture instance or session, capture both relatively low-resolution images at a high frame rate (e.g., 15-30 fps) as well as relatively high-resolution images at a low frame rate (e.g., 3 fps or less). Such operation has been described as “multi-mode” operation and can result in video files (i.e. multi-mode image files) being created that contain embedded high-resolution images.

With such multi-mode image files, the user may view digital video, for instance comprising only the low-resolution images, and can access high-resolution images that are suitable for use as still images. By way of example, the user can extract a high-resolution image from the multi-mode image file, and then use the extracted image as a conventional still image in similar manner to an image captured using a standard digital still camera.

Although such multi-mode operation provides the user with greater flexibility in using captured image data, there currently is no mechanism for determining the origin of a given extracted still image. Therefore, if the user later comes across the extracted still image, the user may have no idea as to which multi-mode image file the image came from, or even whether the image was extracted from a multi-mode image file at all. Assuming that the user does realize that the image was extracted from a multi-mode image file, the user may need to manually review multiple stored video files before the origin of the extracted still image is located. This process is inefficient and, if the user has many stored video files, can waste a large amount of time.

### SUMMARY OF THE DISCLOSURE

Disclosed are systems and methods for associating an image with a video file. In one embodiment, a system and a method pertain to identifying a video file that contains an identified image that is to be stored as a separate still image file, and storing association data along with the still image file that associates the still image file with the video file.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system with which images can be associated with video files.

FIG. 2 is a block diagram of an embodiment of a camera shown in FIG. 1.

FIG. 3 is a graph that plots resolution versus time to illustrate a multi-mode operation of the camera of FIG. 2.

FIG. 4 is a schematic representation of a series of images captured with the camera of FIG. 2 using the multi-mode operation illustrated in FIG. 3.

FIG. 5 is a block diagram of an embodiment of a computing device shown in FIG. 1.

FIG. 6 is a flow diagram that illustrates an embodiment of a method for associating an image with a video file.

FIG. 7 is a flow diagram that illustrates an embodiment of operation of an association manager that is configured to associate an image with a video file.

FIG. 8 is a flow diagram that summarizes an embodiment of a method for associating an image with a video file.

### DETAILED DESCRIPTION

Systems and methods are disclosed that automatically associate with a multi-mode image file, still image files extracted from multi-mode image file. The association may take place when the still image files are created. In some embodiments, a user can easily determine the multi-mode image file from which the still image files originated. Although particular system and method embodiments are disclosed, these embodiments are provided for purposes of example only to facilitate description of the disclosed systems methods. Accordingly, other embodiments are possible.

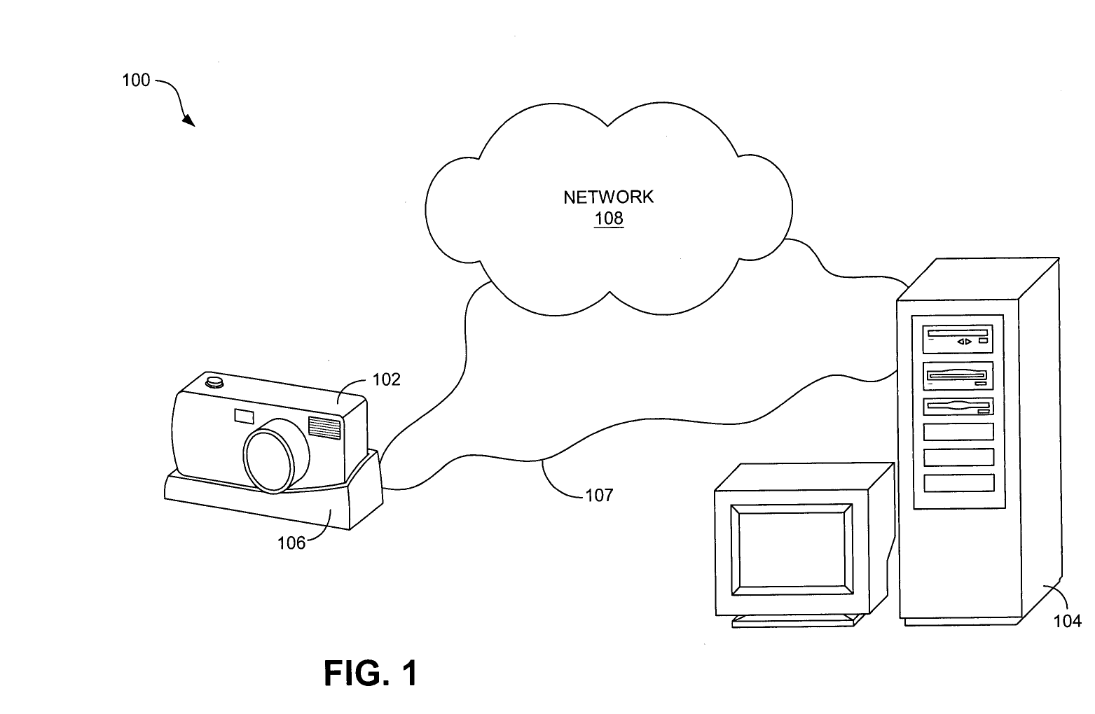

Referring now to the drawings, in which like numerals indicate corresponding parts throughout the several views, FIG. 1 illustrates a system 100 that enables association of extracted still image files with the multi-mode image files from which the extracted still image files originated. As indicated in that figure, the example system 100 comprises a camera 102 and a computing device 104 to which multi-mode image data captured with the camera can be downloaded for viewing and/or storage. By way of example, the camera 102 comprises a digital video camera or a digital still camera that is capable of capturing video data, for example in a “movie” mode.

As indicated in FIG. 1, the computing device 104 may comprise a desktop personal computer (PC). Although a PC is shown and has been identified herein, the computing device 104 can comprise substantially any computing device that can communicate with the camera 102 and manipulate image data received therefrom. Accordingly, the computing device 104 could comprise, for example, a MacIntosh™ computer, a notebook computer, a tablet computer, a personal digital assistant (PDA), or the like.

The camera 102 can communicate with the computing device 104 in various ways. For instance, the camera 102 can directly connect to the computing device 104 using a docking station 106 on which the camera may be placed. In such a case, the docking station 106 may comprise a cable 107 (e.g., a universal serial bus (USB) cable) that can be plugged into the computing device 104. Alternatively, the camera 102 can indirectly “connect” to the computing device 104, for instance via a network 108. The camera's connection to such a network 108 may be via a cable (e.g., USB cable) or, in some cases, via wireless communication. Any number of other means for connecting the camera 102 to the computer 104 could, of course, also be employed, for example direct camera to computer cable connection or infrared connection (not shown).

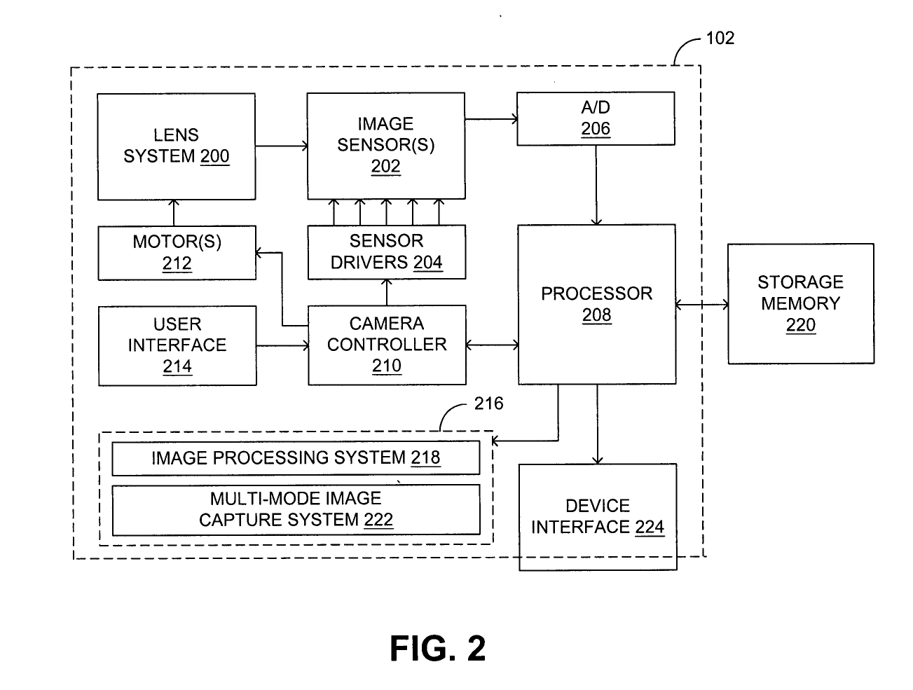

FIG. 2 illustrates an embodiment of the camera 102 used in the system 100 of FIG. 1. Although a camera implementation is shown in FIG. 2 and described herein, the camera 102 more generally comprises an image capture device that can provide images to the computing device 104 in digital form.

The camera 102 includes a lens system 200 that conveys images of viewed scenes to an image sensor 202. By way of example, the image sensor 202 comprises a charge-coupled device (CCD) or a complementary metal oxide semiconductor (CMOS) sensor that is driven by one or more sensor drivers 204. The analog image signals captured by the sensor 202 are provided to an analog-to-digital (A/D) converter 206 for conversion into binary code that can be processed by a processor 208.

Operation of the sensor driver(s) 204 is controlled through a camera controller 210 that is in bi-directional communication with the processor 208. The controller 210 also controls one or more motors 212 that are used to drive the lens system 200 (e.g., to adjust focus and zoom). Operation of the camera controller 210 may be adjusted through manipulation of a user interface 214. The user interface 214 comprises the various components used to enter selections and commands into the camera 102 and therefore can include various buttons as well as a menu system that, for example, is displayed to the user in a back panel display of the camera (not shown).

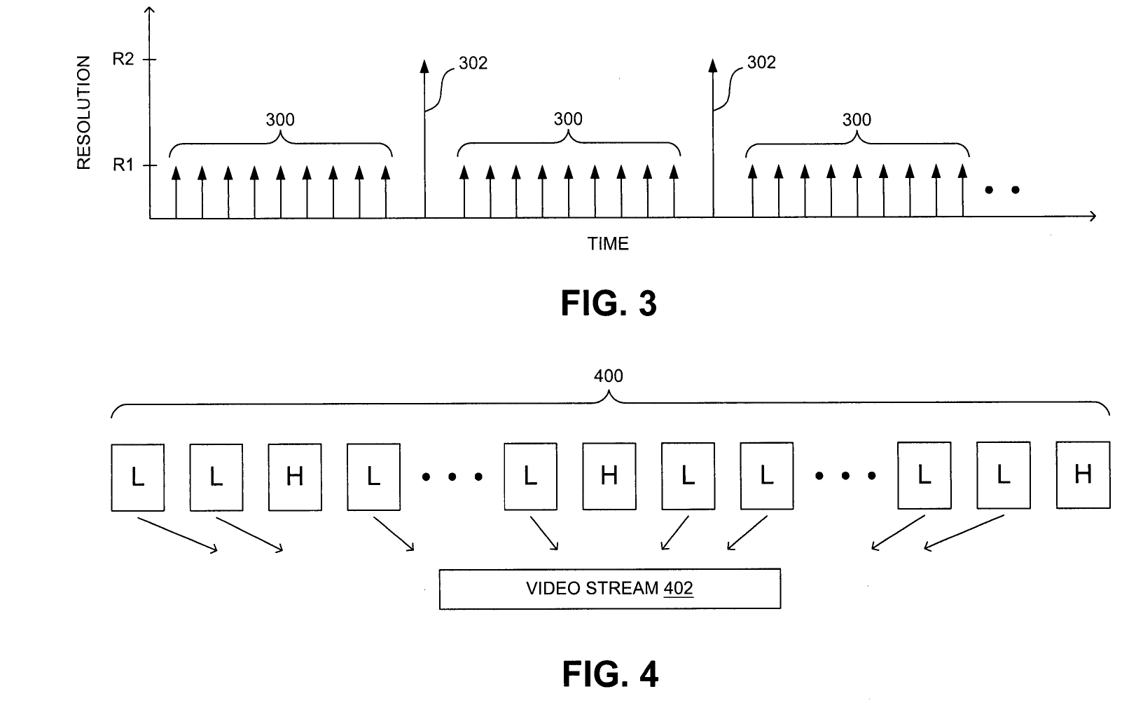

The digital image signals are processed in accordance with instructions from an image processing system 218 stored in permanent (non-volatile) device memory 216. Processed (e.g., compressed) images may then be stored in storage memory 220, such as that contained within a removable solid-state memory card (e.g., Flash memory card). The device memory 216 further comprises a multi-mode image capture system 222 that is configured to control the camera 102 to capture both low-resolution (e.g., video graphics array (VGA)) images at a high frame rate (e.g., 15-30 frames per second (fps)) and high-resolution (e.g., 2 megapixels or more) images at a low frame rate (e.g., up to about 3 frames per second) in a continuous, alternating fashion. Such image capture is described below in relation to FIGS. 3 and 4.

The camera embodiment shown in FIG. 2 further includes a device interface 224, such as a universal serial bus (USB) connector, that is used to connect the camera 102 to another device, such as the camera docking station 106 and/or the computing device 104.

Multi-mode operation of the camera 102 is depicted in the graph of FIG. 3. As shown in FIG. 3, relatively low-resolution images 300 are sequentially captured using the camera 102. In the example of FIG. 3, 10 such images are captured in a row, for instance in a period of about a third of one second (to yield 30 fps). After the last relatively low-resolution image 300 in the given sequence is captured, the camera 102 captures a relatively high-resolution image 302. By way of example, one such relatively high-resolution image 302 can be captured about each third of one second (to yield 3 fps). After the relatively high-resolution image 302 is captured, the process continues with relatively low-resolution images 300 being sequentially captured, a relatively high-resolution image 302 being captured, and so forth as long as the user wishes to capture image data. Therefore, low-resolution images and high-resolution images are captured in the same image capture instance or session (e.g., during a period between when the user starts and when he stops video recording).

FIG. 4 depicts an example of resultant image data created through the multi-mode operation described above in reference to FIG. 3. More particularly, depicted is a series of images 400 that may be contained in a single multi-mode image file. As indicated in FIG. 4, a sequence of relatively low-resolution images, L, and relatively high-resolution images, H, is created, with a greater number of relatively low-resolution resolution images being provided as compared to relatively high-resolution images. As is further indicated in FIG. 4, the relatively low-resolution images, L, can be used to create a video stream 402 that may be presented to a user for viewing. The multi-mode operation depicted in FIGS. 3 and 4 is described in greater detail in commonly-assigned U.S. patent application Ser. No. 10/068,995 entitled “System and Method for Capturing and Embedding High-Resolution Still Image Data into a Video Stream” and having Attorney Docket No. 10011558-1, Feb. 6, 2002, which is hereby incorporated by reference into the present disclosure.

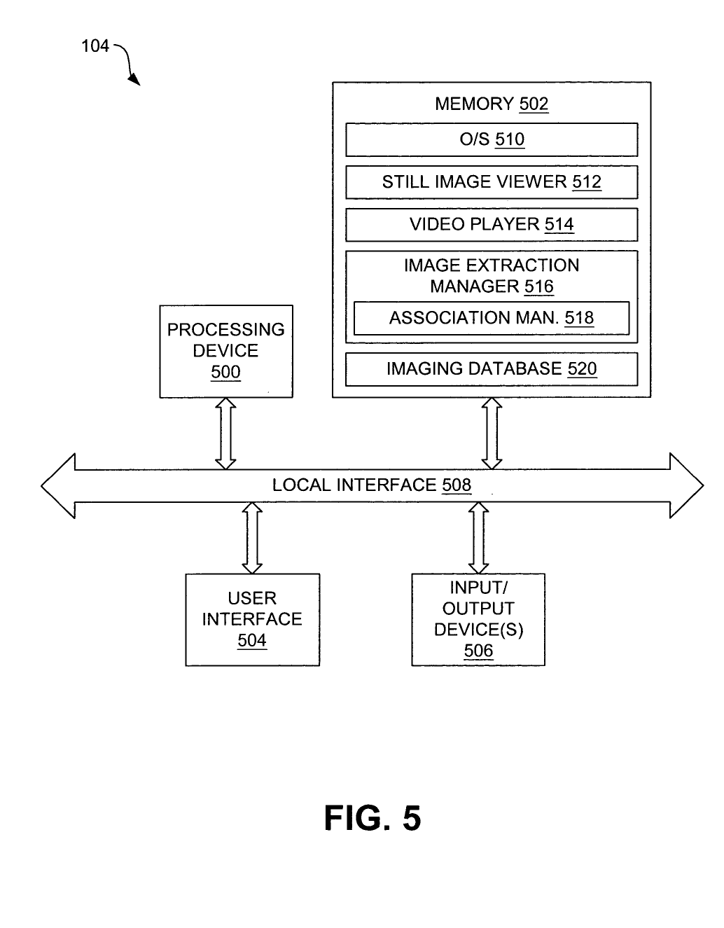

FIG. 5 illustrates an embodiment of the computing device 104 shown in FIG. 1. As indicated in FIG. 5, the computing device 104 comprises a processing device 500, memory 502, a user interface 504, and at least one input/output (I/O) device 506, each of which is connected to a local interface 508.

The processing device 500 can include a central processing unit (CPU) or an auxiliary processor among several processors associated with the computing device 104. The memory 502 includes any one of or a combination of volatile memory elements (e.g., RAM) and nonvolatile memory elements (e.g., read only memory (ROM), Flash memory, hard disk, etc.).

The user interface 504 comprises the components with which a user interacts with the computing device 104, such as a keyboard and mouse, and a device that provides visual information to the user, such as a cathode ray tube (CRT) or liquid crystal display (LCD) monitor.

With further reference to FIG. 5, the one or more I/O devices 506 are configured to facilitate communications with the camera 102 and may include one or more communication components such as a modulator/demodulator (e.g., modem), USB connector, wireless (e.g., (RF)) transceiver, a telephonic interface, or a network card.

The memory 502 comprises various programs including an operating system 510, a still image viewer 512, a video player 514, and an image extraction manager 516. The operating system 510 controls the execution of other software and provides scheduling, input-output control, file and data management, memory management, and communication control and related services. The still image viewer 512 comprises a program with which still image data may be viewed as individual still images, while the video player 514 comprises a program with which video image data can be viewed as streaming video as well as still images.

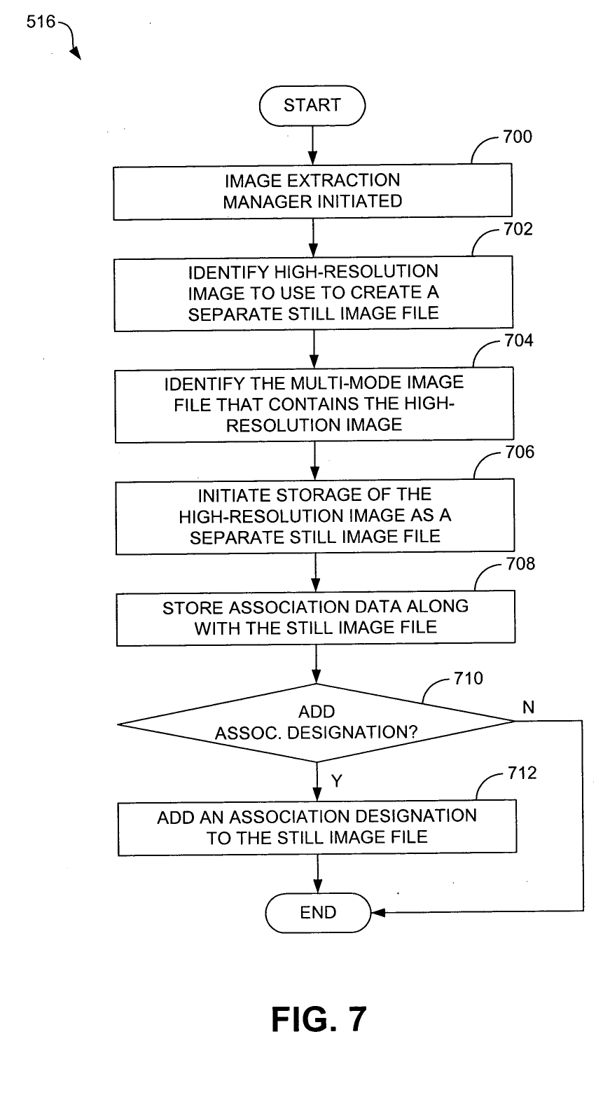

The image extraction manager 516 comprises a program (i.e. logic) that is used to extract individual images, or frames, from video files, such multi-mode image files created in the manner described above. Through such extraction, individual image files may be created. As is further indicated in FIG. 5, the image extraction manager 516 comprises an image/video association manager 518 that, as is discussed below in greater detail in relation to FIG. 7, is configured to associate extracted images (i.e. image files) with video files, such as multi-mode image files.

In addition to the above-mentioned components, the memory 502 may comprise an imaging database 520, for instance located on a device hard disk, that is used to store and arrange image data captured by the camera 102 (still images files and/or video files).

Various programs have been described above. These programs can be stored on any computer-readable medium for use by or in connection with any computer-related system or method. In the context of this disclosure, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

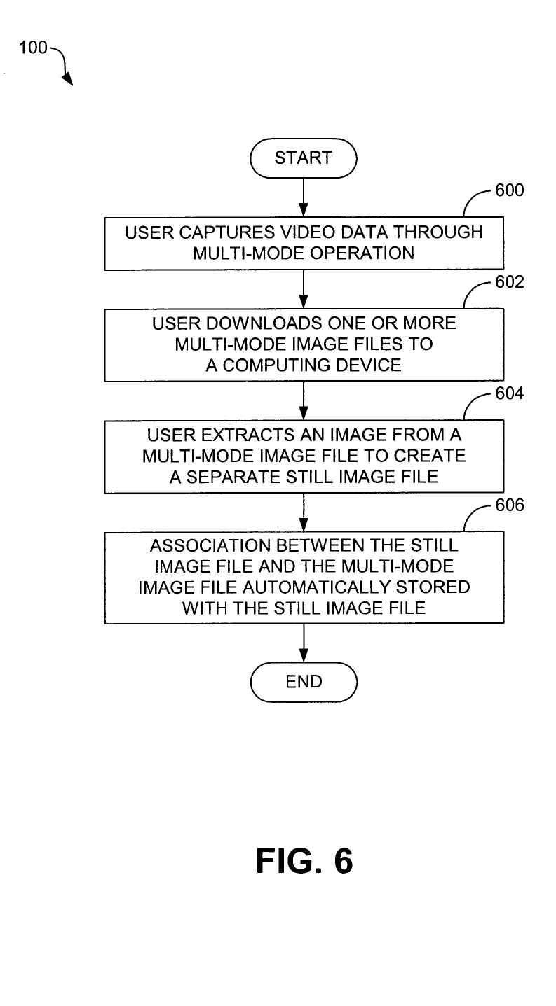

FIG. 6 is a flow diagram that provides an overview of an embodiment of a method for associating an image with a video file to which the image pertains. Process steps or blocks in the flow diagrams of this disclosure may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

Beginning with block 600 of FIG. 6, a user captures video data with a digital camera through multi-mode operation. Accordingly, the user captures both low-resolution and high-resolution images that can be contained within one or more multi-mode image files. Next, with reference to block 602, the user downloads one or more multi-mode image files from the camera to a computing device. This downloading can be effected by, for example, connecting the camera to the computing device, transmitting the data over a network to the computing device, or by inserting a storage medium on which the multi-mode image file(s) was/were stored into an appropriate reader of the computing device.

Once the multi-mode image file(s) is/are downloaded, the user can review the file(s). For instance, the user can view a multi-mode image file as streaming video in an appropriate video player that executes on the computing device. In such a case, the video may comprise only the low-resolution images of the multi-mode image file. Alternatively, the video may comprise the low-resolution images of the multi-mode image file, as well as down-sampled versions of the high-resolution images of the multi-mode image file. In a further alternative, the video may comprise the high-resolution images of the multi-mode image file, as well as up-sampled versions of the low-resolution images.

If during such review, the user identifies a scene (i.e. frame) for which the user would like to create a separate still image file, the user may extract an image from a multi-mode image file to create a still image file, as indicated in block 604. As is described in greater detail below, image extraction can be performed in various ways. For example, the user may simply pause the video stream at the desired point and select an “extract image” command of the video player that initiates the image extraction, and still image file creation, process. Alternatively, the user may pause the video stream and use an appropriate mouse process (e.g., a right-click process) to extract an image. Regardless, extraction causes a still image file, typically having relatively high-resolution, to be created. In some embodiments, the created still image file comprises one of the high-resolution images contained within the given multi-mode image file.

Next, as indicated in block 606, an association between the still image file and the multi-mode image file from which it originated is stored with the still image file. The manner in which this association is stored is described in detail below in relation to FIG. 7. By way of example, the association comprises metadata stored along with the still image file that indicates the identity and/or location of the multi-mode image file. With such metadata, the origin of a given still image file, where applicable, can be determined by the user. At this point, flow for the association instance or session is terminated.

FIG. 7 provides an example of operation of the image extraction manager 516 of the computing device 104. More particularly, FIG. 7 provides an example of the image extraction manager 516 in extracting an image from a multi-mode image file to create a separate still image file, and automatically associating that file with the multi-mode image file from which it originated. Beginning with block 700, the image extraction manager 516 is initiated. Such initiation can occur upon the user entering a command to extract an image from a multi-mode image file. For example, as noted above, that command can be entered by the user while reviewing the multi-mode image file using a video player, for instance player 514 (FIG. 5). In such a case, the user may have been reviewing streaming video with the video player and paused the playing of the streaming video upon identifying a scene in the video that the user would like to have as a separate still image.

The manner in which the extraction command is entered may depend upon the implementation of the image extraction manager 516. For instance, if the manager 516 comprises part of the video player, the command option can be presented to the user with the video player. In some embodiments, the command option may comprise an “Extract Image” button that is presented in the video player template. Alternatively, the command option may be provided in an appropriate menu accessible through the video player. If, on the other hand, the image extraction manager 516 is independent of the video player, and for example comprises part of the underlying operating system (e.g., operating system 510, FIG. 5), the extraction command can be input through other means. In some embodiments, the extraction command can be input using an appropriate mouse procedure. For example, the user can right-click on the paused video stream to cause a pop-up menu to appear that includes an “Extract Image” option that can be selected, for instance by left-clicking on the option. Notably, any other appropriate means for conveying a desire to extract an image can be employed.

Irrespective of the manner in which the image extraction manager 516 is initiated, the manager in one embodiment can then identify a high-resolution image to use to create a separate still image file, as indicated in block 702. The identification process can be performed in various ways and may depend upon the image data that the user is reviewing. For example, if the user is reviewing streaming video that only comprises the low-resolution images of the multi-mode image file, the image extraction manager 516 determines which high-resolution image of the image series that is closest in time and/or content to the image (i.e. frame) that the user has selected. This process can be best understood using an example. Assuming that the multi-mode image file comprises a repeating series of 10 low-resolution images and 1 high-resolution image, and further assuming that the user selected the 7th of a given sequence of low-resolution images, the immediately following (in time) high-resolution image can be identified as the high-resolution image to use to create the separate still image file. To cite another example, if the user selected the 2nd of a given sequence of 10 low-resolution images, the image extraction manager 516 may select the immediately preceding (in time) high-resolution image to create the separate still image file.

With the image extraction manager 516 operating in such a manner, the high-resolution image that is identified will most closely approximate the image (i.e. frame) that the user selected. Other processes may be used to identify the high-resolution image to use as the basis for the separate still image file. Various such processes are described in detail in commonly-assigned U.S. patent application Ser. No. 09/900,072 entitled Digital Video Imaging with High-Resolution Still Imaging Capability” having Attorney Docket No. 10010109-1, filed Jul. 6, 2001, which is hereby incorporated by reference into the present disclosure.

Referring next to block 704, the image extraction manager 516 further identifies the multi-mode image file that contains the high-resolution image identified in block 702 (i.e. the embedded high-resolution image). This identification may comprise one or both of identifying the identity (e.g., filename) of the multi-mode image file and the location (e.g., hard disk location) of the multi-mode image file. The image extraction manager 516 can make this identification by virtue of the multi-mode image file being open, or otherwise active, at the time the extraction occurs. Next, with reference to block 706, the image extraction manager 516 initiates storing of the identified high-resolution image as a separate still image file. Through that process, the image extraction manager 516 may prompt the user to provide a desired filename for the still image file that will be created.

With reference to block 708, the image extraction manager 516 next stores association data along with the still image file. This association data comprises information that links the still image file with the multi-mode image file from which the still image file originated. This information can comprise, for example, the filename of the multi-mode image file and/or the location of the multi-mode image file. By way of example, this information may be conveyed in a format such as: “c:/directory/subdirectory/filename” or the like. Therefore, the information comprises a tag or link that associates the still image file to its parent multi-mode image file. This information may be described as metadata in that it is data that is pertinent to, but separate from, the image data of the still image file.

Optionally, a similar association can be stored with the multi-mode image file that identifies that a separate still image file exists that contains a high-resolution image that is embedded in the multi-mode image file (not shown). In such a case, similar metadata may be added to the multi-mode image file that, for example, identifies the identity and/or location of the separate still image file. Flow from this point depends upon whether a designation is to be added to the still image file to indicate to the user that association data is available and, therefore, that the still image file originated from a multi-mode image file. According, with reference to decision block 710, flow depends upon whether the image extraction manager 516 has been configured (e.g., through a user setting) to add an association designation to the still image file. If not, no further action is required and flow for the association session is terminated. At that point, the user can resume reviewing the streaming video and, if desired, create other separate still image files. If, on the other hand, an appropriate designation is to be provided, flow continues to block 712 at which the image extraction manager 516 adds an association designation to the still image file. Such a designation may comprise, for example, a visible icon provided in a corner of the viewed image that indicates to the user that the image was extracted from a multi-mode image file (i.e. a video file). Alternatively, the designation can comprise an asterisk or other indicator that is added to the filename of the still image file that will be visible when the filename is shown to the user (e.g., in the storage directory).

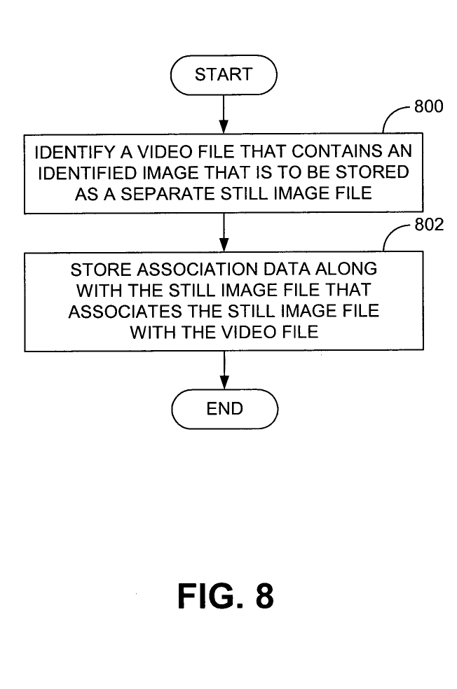

In view of the above disclosure, a method for associating an image with a video file may be summarized as provided in FIG. 8. As indicated in that figure, a video file is identified that contains an identified image that is to be stored as a separate still image file (block 800), and association data is stored along with the still image file that associates the still image file with the video file (block 802). The above described embodiments have dealt primarily with the storage of high resolution files that were generated along with low resolution files of a video clip. However, it will be appreciated that this methodology may also be employed to create a low resolution still image file that associates the still image with a data clip from which it was extracted. In other words the process may be suitably modified and employed to extract and associate video clip identifying data with an ordinary video frame of a conventional video clip containing only low resolution frames as well as to a multi-mode created in video clip of the type shown in FIGS. 3 and 4.

1. A method for associating an image with a video file, the method comprising:
identifying a video file that contains an identified image that is to be stored as a separate still image file; and
storing association data along with the still image file that associates the still image file with the video file.

2. The method of claim 1, wherein identifying a video file comprises identifying a multi-mode image file that comprises low-resolution images and at least one high-resolution image.

3. The method of claim 1, wherein identifying a video file comprises identifying at least one of an identity of the video file and a location of the video file.

4. The method of claim 1, wherein identifying a video file comprises identifying a video file that contains an identified high-resolution image that is to be stored as a separate still image file.

5. The method of claim 1, wherein storing association data comprises adding metadata to the separate still image file.

6. The method of claim 5, wherein adding metadata comprises adding metadata that includes at least one of an identity and a location of the video file.

7. The method of claim 1, further comprising adding an association designation to the separate still image file.

8. The method of claim 7, wherein adding an association designation comprises adding an icon that is visible when the image of the separate still image file is viewed.

9. The method of claim 7, wherein adding an association designation comprises adding an indicator to the filename of the separate still image file.

10. A system for associating an image with a video file, the system comprising:
means for identifying at least one of an identity and a location of a video file that contains an image that is to be stored as a separate still image file; and
means for automatically storing association data along with the still image file, the association data associating the still image file with the video file.

11. The system of claim 10, wherein the means for identifying comprise means for identifying at least one of an identity and a location of a multi-mode image file that comprises low-resolution images and at least one high-resolution image.

12. The system of claim 10, wherein the means for automatically storing association data comprise means for adding at least one of an identity and a location of the video file to the separate still image file.

13. The system of claim 10, further comprising means for adding an association designation to the separate still image file.

14. The system of claim 13, wherein the means for adding an association designation comprise at least one of means for adding an icon that is visible when the image of the separate still image file is viewed and means for adding an indicator to the filename of the separate still image file.

15. A system stored on a computer-readable medium, the system comprising:
logic configured to identify a multi-mode image file that contains an identified image that is to be stored as a separate still image file; and
logic configured to store association data along with the still image file that associates the still image file with the multi-mode image file.

16. The system of claim 15, wherein the logic configured to identify comprises logic configured to identify at least one of an identity of the multi-mode image file and a location of the multi-mode image file.

17. The system of claim 15, wherein the logic configured to add association data comprises logic configured to add metadata to the separate still image file that includes at least one of an identity and a location of the multi-mode image file.

18. The system of claim 15, further comprising logic configured to add an association designation to the separate still image file, the association designation comprising at least one of an icon that is visible when the image of the separate still image file is viewed and an indicator to the filename of the separate still image file.

19. A method for extracting an image from a video file, the method comprising:
identifying an image embedded in a video file;
storing a separate still image file comprising the identified image; and
storing association data that associates the separate still image file with the video file.

20. The method of claim 19, wherein identifying an image comprises identifying an image that is closest in time or content to a video frame selected by a user.

21. The method of claim 19, wherein identifying an image comprises identifying a high-resolution image embedded in a multi-mode image file that contains low-resolution images and high-resolution images.

22. The method of claim 19, wherein storing association data comprises adding metadata to the separate still image file that identifies at least one of an identity and a location of the video file.

23. The method of claim 19, wherein storing association data comprises adding metadata to the video file that identifies at least one of an identity and a location of the separate still image file.

24. The method of claim 19, further comprising adding an association designation to the separate still image file that indicates that the separate still image file is associated with the video file.

25. The method of claim 24, wherein adding an association designation comprises at least one of adding an icon that is visible when the image of the separate still image file is viewed and adding an indicator to the filename of the separate still image file.

26. An image extraction manager stored on a computer-readable medium, the manager comprising:
logic configured to identify an image embedded in a video file;
logic configured to store the identified image as a separate still image file; and
an image/video association manager that includes to logic configured to identify a the video file in which the identified image is embedded and logic configured to add association data to the still image file, the association data associating the still image file with the video file.
